(19) United States
(12) Patent Application Publication
(10) Pub. No.: US 2013/0186958 A1
(43) Pub. Date: Jul. 25, 2013

(54) SYSTEM AND METHOD FOR IMPRINTING SYMBOLOGY ONTO A LIVING BEING FOR PERSONAL DATA CORRELATION

(71) Applicant: Leigh M. Rothschild, Sunny Isles Beach, FL (US)

(72) Inventor: Leigh M. Rothschild, Sunny Isles Beach, FL (US)

(73) Assignee: Ariel Inventions, LLC, Sunny Isles Beach, FL (US)

(21) Appl. No.: 13/356,209

(22) Filed: Jan. 23, 2012

(51) Int. Cl. G06K 19/00

(52) U.S. Cl. 235/487

(57) ABSTRACT

Embodiments of the present invention provide a method and system for providing personal data to others. In accordance with one embodiment, the system includes a symbology device including a processor. The processor determines personal data corresponding to a person and determines a code to imprint based at least in part on the personal data. At least a portion of the personal data is represented in the code. The symbology device includes an imprinter arranged to imprint the code onto the person.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to storing and providing information about a person using symbology imprinted onto a human.

### BACKGROUND OF THE INVENTION

The accurate storage, retrieval and providing of personal information has become an important aspect of modern life. A person continuously provides personal information, like a telephone number, home address, etc., to many different requesters. The requesters may be friends, coworkers, government authorities, retailers, financial institutions, etc. When a person is asked to provide personal information, the person may, for example, write down the requested personal information on a paper, fill out a document or may simply verbally provide the information to the requester so that the requester may write it down.

It is cumbersome to provide the same personal information over and over again to different requesters. For example, a person may be asked for his or her social media identification or email address by a couple of requesters. If the person has many social media identifications and many different email addresses, the person may have to write down every single social media identification and email address on a piece of paper numerous times, or each of the requesters may have to write the information themselves. Sometimes, the person may send the personal information electronically to each requester. Each requester may request a different set of personal information, which may require customizing the personal information for each requester. Some personal information may be basic personal information that the person may wish to share with everyone, such as a social media identification. Other personal information may be more private, such as the person's social security number.

It is desirable to have a system and method that allows personal information to be conveniently provided to others.

### SUMMARY OF THE INVENTION

The present invention advantageously provides a device, system and method for providing personal data to others and linking the stored personal data to symbology imprinted on a person.

According to one embodiment, a system is provided. The system includes a symbology device having a processor that determines personal data corresponding to a person, and determines a code to imprint based at least in part on the personal data. At least a portion of the personal data is represented in the code. The symbology device also includes an imprinter arranged to imprint the code onto the person.

According to another embodiment, a method is provided. The method determines personal data corresponding to a person and determines a code to imprint based at least in part on the personal data. At least a portion of the personal data is represented in the code. The code is imprinted onto the person.

According to yet another embodiment, tangible computer readable medium is provided. The computer readable medium stores computer readable instructions that when executed by the computer, cause the computer to determine personal data corresponding to a person, and determine a code to imprint based at least in part on the personal data. At least a portion of the personal data is represented in the code. The code is imprinted onto the person. According to another embodiment, a method is provided. The method determines creature data corresponding to a creature and determines a code to imprint based at least in part on the creature data. At least a portion of the creature data is represented in the code. The code is imprinted onto the creature.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a system for storing personal data and linking the stored personal data to symbology, constructed in accordance with the principles of the present invention;

FIG. 2 is a flow chart of an exemplary process for initiating the imprinting of symbology and storing the corresponding personal data in accordance with the principles of the present invention;

FIG. 3 is a flow chart of an exemplary process for storing and retrieving personal data in accordance with the principles of the present invention;

FIG. 4 is a block diagram of an exemplary symbology device constructed in accordance with the principles of the present invention; and

FIG. 5 is a flowchart of an exemplary process for transmitting personal data in accordance with the principles of the present invention.

### DETAILED DESCRIPTION OF THE INVENTION

The present invention advantageously provides a system and method for storing personal data, linking the stored personal data to symbology and making the personal data available to others. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

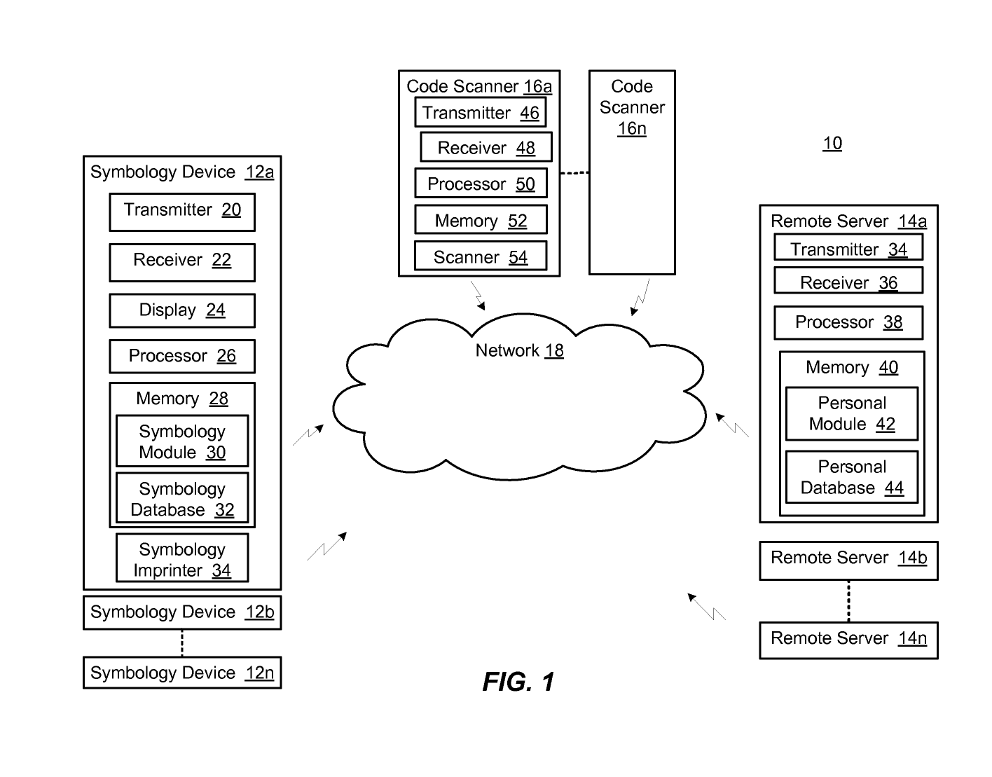

Referring now to the drawings figures in which like reference designators refer to like elements, there is shown in FIG. 1 an exemplary personal record storage and linking system constructed in accordance with the principles of the present invention and designated generally as “10.” In particular, system 10 may form one or more cloud computing environments for storing identification (ID) data and corresponding personal data or creature data, such as name and age data, personal history data, and personal communication data, among other data. Symbology refers to a code that is imprinted on/in a portion of a human being, other mammals or other creatures. For ease of explanation, personal data and creature data are referred to collectively herein as personal data. As used herein, creature refers to a non-human living thing in which creature data is data personal information related to the creature.

System 10 includes one or more symbology devices 12a to 12n (collectively referred to as “symbology device 12”), one or more remote servers 14a to 14n (collectively referred to as “remote server 14”), one or more code scanners 16a to 16n (collectively referred to as “code scanner 16”), communicating via network 18. Network 18 may include wired and/or wireless data communication networks such as an Internet Protocol network, among other networks that allow for data communications. While symbology device 12 and code scanner 16 are shown as separate elements, they may also be incorporated into one device (not shown).

Symbology device 12 may be a mobile device, personal computer, laptop computer, tablet computer, PDA, among other types of computers. Symbology device 12 may include transmitter 20 and receiver 22 for communicating with code scanner 16 and/or remote server 14, via network 18. Display 24 may display information and/or the code to be imprinted to the person. Display 24 may be a cathode ray tube (CRT) display, liquid crystal display (LCD), light-emitting diode (LED) display, touch screen display, among other types of displays. Processor 26 may include a central processing unit (CPU) for performing symbology device 12 functionality. Memory 28 may include symbology module 30, symbology database 32, among other modules and databases.

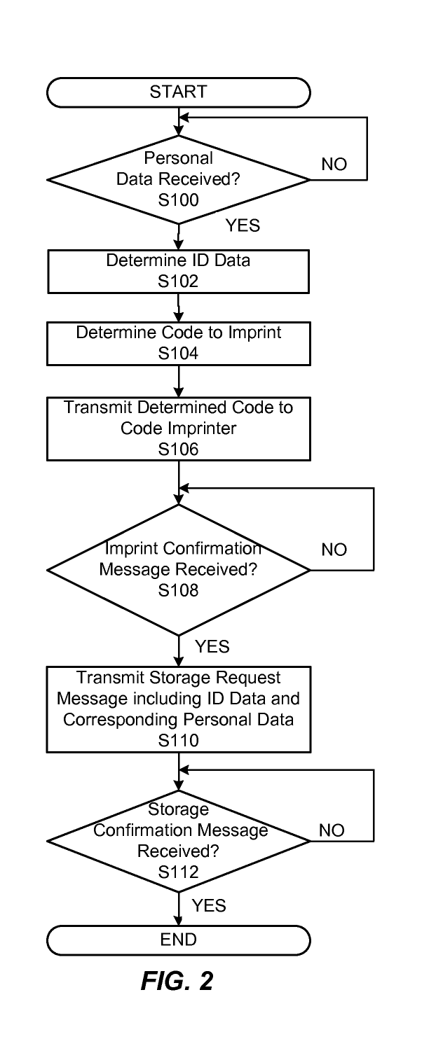

In particular, memory 28 may include a non-volatile and volatile memory. For example, non-volatile memory may include a hard drive, memory stick, flash memory and the like. Also, volatile memory may include random access memory and others known in the art. Symbology module 30 may be computer program instructions stored in memory 28, which when executed by processor 26, initiates imprinting of symbology and storing of corresponding personal data functions as discussed with respect to FIG. 2.

Symbology database 32 may include a variety of codes that may be imprinted onto a living creature. The codes or symbologies may include one dimensional (1D) codes, two dimensional (2D) codes such as a MICROSOFT tag code, a Quick Response (“QR”) code, among other types of codes that may represent at least a portion of identification (ID) data. For example, the codes may be optical machine readable codes such as a series of parallel lines or a graphical drawing. For example, the code may be a drawing of a “happy face” such that ID data is represented (e.g., via barcode, characters) in the happy face, and the happy face is imprinted onto the living creature, as discussed in detail with reference to FIG. 2. Symbology device 12 may include a Global Positioning System (GPS) component or module that provides location/position and time information, among other GPS information. Symbology device 12 may be implemented using hardware or a combination of hardware and software.

Symbology imprinter 34 may include a mechanism for imprinting a code (i.e., symbology) on a portion of a human, other mammal, and/or other creature. For example, symbology imprinter 34 may be a needle based ink injection mechanism, laser based mechanism, ultraviolet light based mechanism, among other types of mechanisms that may cause a permanent, semi-permanent or temporary imprint of the code on a portion of a living creature.

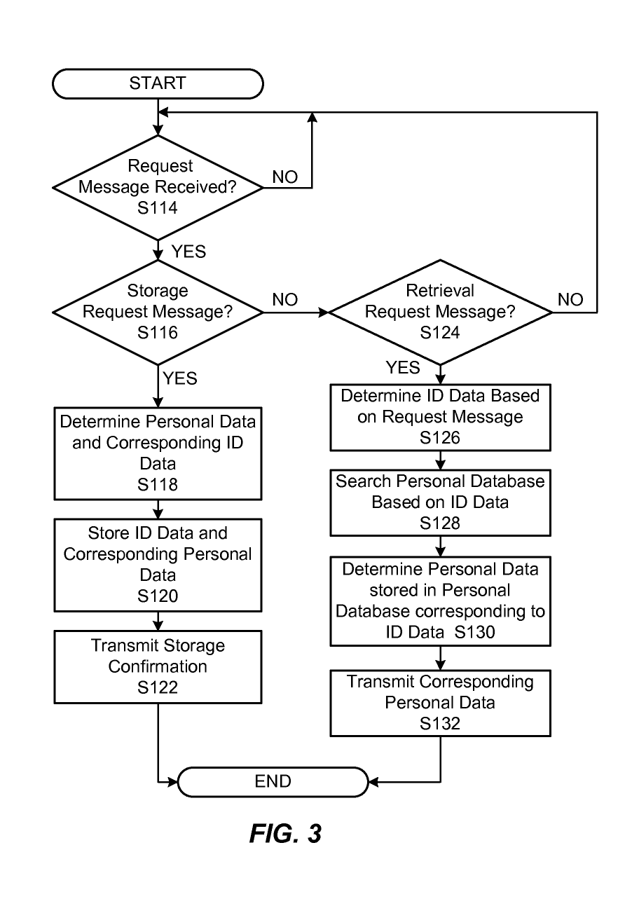

Remote server 14 may include transmitter 34, receiver 36, processor 38 and memory 40 as with the corresponding symbology device 12 components, with size and performance being adjusted based on design requirements. Processor 38 may perform functions described herein with respect to remote server 14. Memory 40 may include personal module 42 and personal database 44. In particular, personal module 42 includes instructions, which when executed by processor 38, causes processor 38 to store and retrieve personal data, discussed in detail with reference to FIG. 3.

Personal database 44 may include personal data for one or more persons and ID data corresponding to the personal data, e.g., each person may have ID data and corresponding personal data. For example, a code may be associated with personal data that may include name, age, date of birth, physical address, email address, social media identification, telephone number, SMS address, other communication identifiers, work history, personal history, and family and friends information, including linking to social networking sites or any other information that the user may wish to store. In particular, personal database 44 associates particular personal data with ID data (e.g., personal identification number) such that a search of personal database 44 for specific ID data will return corresponding personal data, as discussed in detail with reference to FIG. 3. Of note, although personal data is described herein as being stored in a “database”, the invention is not limited to storage in a formal database management system, e.g., SQL. It is contemplated that any memory storage device can store the patent data in an organized and retrievable form, e.g., flat file.

Personal database 44 may also include a list of users who may be authorized to access the personal data. Additionally, personal database 44 may include the extent to which the personal data may be accessed by each other user. For example, users not on the list may be able to access some default, i.e., basic, personal data, such as a person's email address, while users on the list may have access to all or part of the personal data. Personal data may be categorized in different security levels, such as first level personal data, second level personal data and third level personal data. Users on the list may be authorized to access at least one of first, second or third level personal data. First level personal data may be less private than third level personal data. For example, first level personal data may include a link to a social media website associated with a person, while third level personal data may include a social security number. Personal data may also be categorized by type or class. For example, some requesters may be able to access personal data classified as contact information, like a telephone number. Other personal data may be classified as business personal data, financial personal data, educational personal data, etc. For example, personal data classified as financial personal data may include financial information associated with the person.

Personal data may include, but may not be limited to an online profile user identification, a web address, the age, sex, education, work history and resume of a person, a list of addresses of a person's contacts, a social network link, family history and genealogy, group memberships, photos, videos, user names, friends, calendar data, events associated with a person, a person's favorite retailers, shopping habits, blogging webpage, a list of property owned by a person, previous names used, affiliations links to contacts, social and professional networks, information related to life events, such as a marriage or divorce, military service, a person's preferences or tastes, a list of goods bought, taxes information, credit rating, corporations associated with a person, assets and liabilities, income and bank accounts associated with a person. Personal data may include comments or any other information the user may wish to store. The code may be based at least in part on the personal data.

The code may also be associated with personal data that includes, but may not be limited to an internet chatting identification, instant message identification, a government identification, a financial institution identification, a social group identification, a preferred communication medium, a news feed site, a live streaming video channel, a document, a text file, a multimedia file, a sound file, a graphical file, and a record of communications between the person and a third party via text, chat, email, etc. For example, documents may include but may not be limited to a birth certificate, a driver license, a medical file, a passport, university records, an application for scholarships, criminal records and a living will. A multimedia file may be, for example, a work related presentation, a movie, etc.

Additionally, the code may be associated with data that includes a message customized for the person. The message may be classified as an important message or a regular message. A regular message may include personalized health related information, such as blood type and medicines that the person is taking, or communication information, such as the language spoken by the person. An important message may include health allergies.

Code scanner 16 may be a mobile phone device, personal computer, laptop computer, tablet computer, personal digital assistant (PDA), among other types of devices that may include scanner 54. Alternatively, scanner 54 may be an attachment that may connect to code scanner 16 via universal serial bus (USB), among other connections types. Code scanner 16 may include transmitter 46, receiver 48, processor 50 and memory 52 that may function substantially the same as the corresponding symbology device 12 components, with size and performance being adjusted based on design needs.

In particular, memory 52 may include computer program instructions, which when executed by processor 50, cause processor 50 to operate scanner 54 to enable scanning and processing of the imprinted code. For example, scanner 54 may be a digital camera that is included in a mobile phone in which the digital camera captures an optical image of the imprinted code and reads/decodes the captured image for ID data. Alternatively, scanner 54 may include other types of scanners that scan or capture the imprinted code, e.g., laser scanner and charge-coupled device (CCD) reader.

An exemplary process for initiating the imprinting of symbology and storing of corresponding personal data corresponding to a person is described with reference to FIG. 2. A determination is made whether personal data has been received (Step S100). For example, personal data may be input into symbology device 12 by the person or a third party, via input mechanisms, e.g., keypad or keyboard, or some or all of the personal data may be received from a central server (not shown) that contains previously stored personal data. Continuing the example, personal data may be received from a person's social media page or other webpages. Personal data may also be sent by remote server 14 to symbology device 12. If no personal data has been received, the determination of Step S100 may be repeated.

Alternatively, a network administrator, or a person may be notified (not shown). If the personal data is received, symbology device 12 determines the ID data corresponding to a living creature (person), e.g., ID data corresponds to personal data specific to a person (Step S102). ID data may include a person's ID number, name, date of birth, digital images of the person, a government identification number, among other data. The ID data may be determined based in part on the family relationships of the person, among other criteria. For example, a person's ID data may be similar for persons of the same family or belonging to a same network, such as a university network. The ID data may be a string of characters strings such as alpha, numeric or alpha-numeric characters. The ID data may be sent by remote server 14 to symbology device 12.

If the ID data is determined, symbology device 12 determines which code to imprint on the living creature, e.g., human person (Step S104). In one embodiment, server 14 may determine which code to imprint and send the code to symbology device 12. The determined code to imprint may be based at least on one of the determined ID data and the personal data. For example, the code may be determined based on the personal identification number. Continuing the example, a short personal identification number (e.g., 6 characters) may correspond to a 1D code (barcode) such that the imprinting time is minimized. Continuing the example, a long personal identification number, e.g., 20 characters, may correspond to a 2D code that requires less space to imprint than a 1D code using the same characters.

The determined code to imprint may be based at least in part on other factors such as social media identification of the person, personal data, date code is imprinted, a person's contact information, size of identification (ID) data to be imprinted, personal history, relationship history, size of personal data, type of personal data and/or other criteria. For example, certain codes may be specific to the geographic location of the person such as continent, region or locality. Continuing the example, certain codes may be specific to geographic information (GPS information) provided by GPS component such as the geographic location where symbology device 12 is being used. Moreover, certain codes may be specific to the date of birth of the person and/or certain types of personal data may correspond to specific codes, e.g., social security number, may correspond to a specific 2D code in which the ID data is represented by the code. Type of personal data may correspond to sensitivity of personal data (e.g., highly personal data) and/or priority of personal data (e.g., high priority personal records such as emergency contact information, and lower priority personal records such as educational data).

The determined code to imprint may be based at least in part on inputs from the person or a third party (e.g., another factor). For example, display 24 may display different types of codes that may be imprinted onto the person in which the user or person may select a code, via an input mechanism such as coding device button, touch screen button, voice command, mouse input device, among other input mechanisms. Continuing the example, the person may prefer a 1D barcode as opposed to a 2D barcode such that a 1D barcode with ID data is imprinted onto the person as discussed with respect to step S106. Determining the code to imprint is not limited to these factors and may be based at least in part on other factors.

The determined code may be a graphical drawing. For example, the determined code may be a drawing of a “happy face” such that the ID data is included or represented by at least part of the drawing. Continuing the example, ID data may include personal ID number “110” that may be imprinted as part of the outline of the happy face. For example, a portion of the outline of the happy face may be replaced by the 1D barcode. Alternatively, personal ID number may be represented by the happy face itself such that each happy face drawing corresponds to specific ID data. For example, a closed eye on the happy face may represent a “1”, an open eye may represent a “0”, the variety of happy face mouth configurations may correspond to characters “000” to “999”, among other happy face characteristics that may correspond to a specific character(s). While the example includes a drawing of a happy face, other graphical drawings may be used in place of the happy face. The determined code may also incorporate a picture, a diagram or any type of graphic. For example, the determined code may be a MICROSOFT TAG code that encodes information and graphics.

The determined code (e.g., symbology) may represent at least a portion of the ID data. In particular, the identification data may be imprinted directly onto or into the person without changing the representation of the identification data. For example, person identification number (e.g., ID data) of “123456” may be imprinted as “123456” on the person as opposed to changing the representation of “123456” into a 1D code (e.g., barcode). The ID data may be readable by code scanner and/or a human without decoding, e.g., numeric numbers (ID data) imprinted onto person such that they can be read by others without code scanner 16. Alternatively, the determined code may be encoded with ID data (not shown).

In particular, a one dimensional code maybe encoded with some or all of the ID data. For example, the ID data (e.g., personal ID number “110”) may be encoded such that the encoded ID data (e.g., encoded personal ID number “110110110”) is then included as part of the code. Using encoded ID data may provide added security in protecting the personal ID number and corresponding personal data. The code may be encoded with some or all of the personal data. For example, personal data, such as person's home and work addresses, may be encoded into the code such that code scanner 16 is able to decode personal data based on the scanned code. Other personal data may also be encoded into the code. Continuing the example, ID data (e.g., personal number or encoded personal number) may also be included in the code along with the encoded personal data.

The determined code is transmitted to symbology imprinter 34 such that the code is imprinted onto the living creature, e.g., at least a portion of the ID data is represented in the code that is imprinted onto the living creature (Step S106). A determination is made as to whether an imprint confirmation message has been received indicating the code was successfully imprinted (Step S108). If it is determined no imprint confirmation message has been received, the determination of Step S108 may be repeated. Alternatively, a network administrator, a third party and/or the person may be notified (not shown). If an imprint confirmation message is received, the determined ID data and corresponding personal data may be transmitted to remote server 14 via a storage request message, e.g., ID data, corresponding personal data and/or other data may be transmitted to remote server 14 for storage, including other data such as GPS information (Step S110).

The storage request message may include a password and/or login input by the person or a third party corresponding to ID data and/or personal data. For example, the password may be linked to ID data and personal data such that remote server 14 will only retrieve personal data when the password and corresponding ID data are received in the retrieval request message as discussed in detail with respect to FIG. 3. Continuing the example, the person or a third party may enter a password into the code scanner that may be transmitted along with the personal data. A determination is made if a storage confirmation message has been received (Step S112). For example, the storage confirmation message may indicate successful storage of ID data and corresponding personal data in personal database 44 at remote server 14, e.g., storage in a cloud computing environment. The storage confirmation message is discussed in detail with respect to FIG. 3. If no storage confirmation message is received, the determination of Step S112 may be repeated. Alternatively, the network administrator, a third party and/or the person may be notified (not shown).

An exemplary process for storing and retrieving personal data is described with reference to FIG. 3. A determination is made whether a request message is received (Step S114). For example, a request message may be received from symbology device 12, code scanner 16, via a website, among other devices and/or interfaces. If it is determined no request message is received, the determination of Step S114 may be repeated. Remote server 14 may receive the personal data request message.

If it is determined that a request message is received, a determination is made whether the request message is a storage request message (Step S116). For example, a storage request message may indicate that ID data and corresponding personal data are to be stored in personal database 44, e.g., indicated by a triggered flag in the message. If it is determined that the receive request is a storage request message, the personal data and corresponding ID data in the storage request message are determined, e.g., process request message for ID data and corresponding personal data (Step S118). Additionally, a determination of whether the user is authorized to access personal information may be made. For example, it may be determined that the user is authorized to access at least one of first, second and third level personal data.

The storage request message may also include a password and login that corresponds to the ID data and/or personal data. The storage request message may additionally include information about the user requesting the information and whether the user is authorized to access the personal data. For example, a password may be entered by a third party or the person via the input mechanism on symbology device 12, such that the ID data and/or personal data are linked to the password. The password may be composed of alpha, numeric or alpha-numeric characters. The password may provide added security such that at least the password and corresponding ID data are needed to recover personal data. The login may be a series of characters specific to a person, a third party or other user. For example, the login may be a username such as the person's social media identification followed by a number.

The storage request message may include a person's status information to be stored, e.g., a person's status update. The status update may be displayed at a person's social media website so that third parties, such as the person's friends can read the status update. The determined ID data and corresponding personal data from the storage request message are stored in personal database 44 in which personal data is linked to the ID data (Step S120). For example, a flag or table may be updated in personal database 44 indicating specific ID data corresponds to specific personal data. A storage confirmation message may be transmitted upon successful storage in personal database 44 of the personal data and corresponding ID data (Step S122). For example, the storage confirmation message may be transmitted from remote server 14 to code scanner 14, symbology device 12, laptop computer, tablet computer, among other devices.

Referring back to Step S116, if it is determined the request message is not a storage request message, a determination is made whether the request message is a retrieval request message (Step S124). The retrieval request message may indicate specific personal data to be retrieved from personal database 44. If it is determined the request message is not a retrieval request message, the determination of Step S116 may be repeated. Alternatively, a network administrator, a third party and/or person may be notified (not shown). If the request message is determined to be a retrieval request message, the ID data in the retrieval request message is determined, e.g., process retrieval request message for ID data (Step S126). For example, the retrieval request message may contain ID data, such as a personal identification number that was transmitted by code scanner 16, among other data that may identify a person. Remote server 14 may receive the retrieval request message.

A password and login may be included in the retrieval request message. For example, the password may be input, via the input mechanism on the code scanner, by a third party and/or person. A password offers added security in that only certain people who known the password may retrieve personal data corresponding to the ID data. Additionally, it may be determined whether the user requesting the personal data is an authorized user. Personal database 44 may be searched based on the determined ID data (e.g., personal identification number) from the retrieval request message, e.g., the personal data is retrieved based at least in part on the determined ID data (Step S128). The request message may also include a personal data access level indicating the access level that the requester has with respect to the personal data. For example, the requester may be authorized to access all or part of the personal data. The request message may also include a type of personal data that the user is authorized to access.

The personal data corresponding to the determined ID data is determined (Step S130). If there is no corresponding personal data stored in personal database 44, a network administrator, a third party and/or person may be notified, and/or another personal database may be searched (not shown). The determined corresponding personal data stored in personal database 44 may be transmitted by remote server 14 (Step S132). For example, the determined corresponding personal data may be transmitted to code scanner 16, symbology device 12, among other devices capable of receiving personal data, e.g., personal data is transmitted to the device that transmitted the retrieval request message. All or a portion of the stored personal data may be transmitted. For example, a third party may only request a portion of personal data in which symbology device 12 may indicate this specific request in the retrieval request message. Additionally, the personal data transmitted may correspond to the personal data access level of the requester and/or the type of personal data the requester is authorized to access.

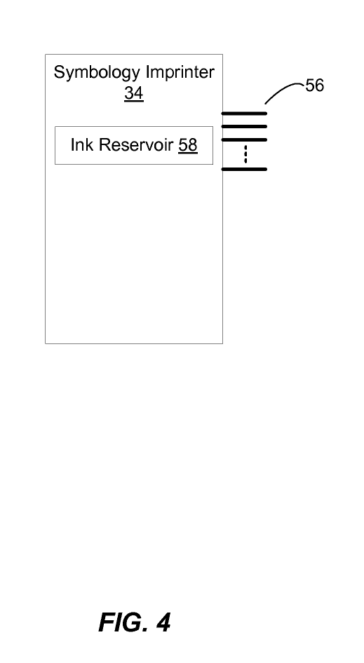

An exemplary symbology device 12 for imprinting symbology is described with reference to FIG. 4 in which reference elements of symbology device 12 are shown in FIG. 1. Symbology device 12 may use a needle based injection mechanism to imprint symbology onto a living creature. For example, one or more needles (“needle 56”) many inject ink into or onto a living creature. The ink may be visible under the visible light spectrum, under ultraviolet light spectrum, among under other lighting conditions. The ink may be stored in ink reservoir 58, e.g. ink is dispensed from ink reservoir 58 to needle 56.

Alternatively, symbology device 12 may include other mechanisms for imprinting symbology onto a living creature. For example, symbology device 12 may imprint symbology (e.g., code) using a mechanism that forms bumps on the living creature similar to skin bumps found in tribal cultures. Symbology device 12 is not limited these types of imprinting mechanisms and may include other imprinting mechanism such as a laser based imprinting mechanism that uses one or more lasers to imprint symbology onto a living creature.

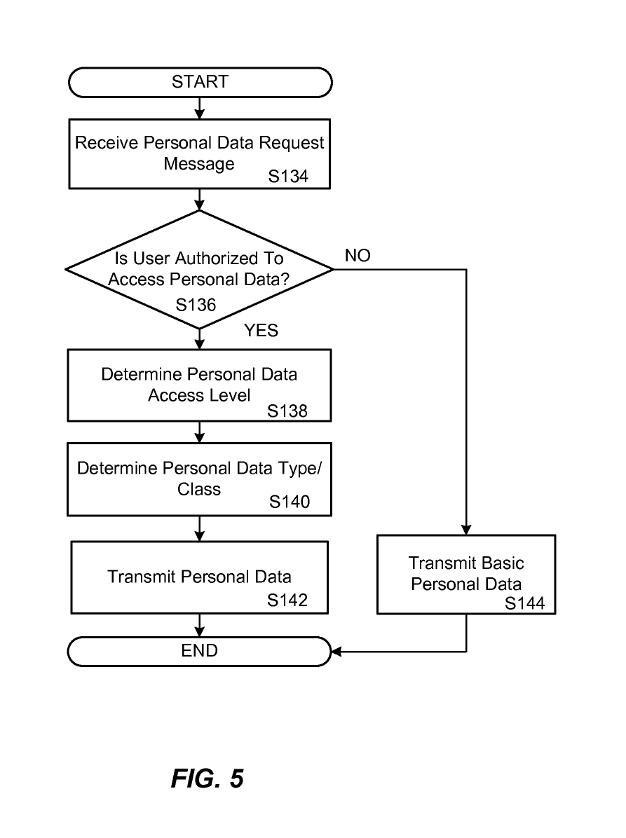

FIG. 5 is a block diagram of an exemplary process for transmitting personal data. A personal data request message may be received (Step S134). A determination may be made as to whether the user is authorized to access personal data (Step S136). If the user is an authorized user, the personal data access level may be determined, i.e. the level of personal data the user is authorized to access (Step S138). Additionally, the personal data type/class may also be determined, i.e. the type/class of personal data the user is authorized to access (Step S140). Personal data corresponding to the at least one personal data access level and personal data type may be transmitted (Step S142). If the user is not an authorized user, basic personal data is transmitted (Step S144).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A system, comprising:
a symbology device, the symbology device including:
a processor, the processor:
determining personal data corresponding to a person;
determining a code to imprint based at least in part on the personal data, at least a portion of the personal data being represented in the code; and
an imprinter, the imprinter arranged to imprint the code onto the person.

2. The system of claim 1, the symbology device further comprising:
at least one of an input mechanism and receiver in communication with the processor, the receiver receiving personal data; and
a transmitter in communication with the processor, the transmitter transmitting the personal data.

3. The system of claim 2, wherein the receiver receives a storage confirmation message indicating that the personal data has been stored.

4. The system of claim 1, wherein the personal data includes a uniform resource locator (URL) to a website associated with the user.

5. The system of claim 1, wherein the code is a graphical drawing.

6. The system of claim 1, wherein the imprinter includes a needle based injection mechanism to inject an ink into the person, and wherein the ink is one of a first ink visible under a visible light spectrum and second ink visible under an ultraviolet light spectrum.

7. The system of claim 1, wherein the personal data includes at least one of a government identification and a social media user identification associated with the person.

8. The system of claim 1, further comprising:
a server in communication with the symbology device, the server comprising:
a server receiver, the server receiver receiving a personal data request message; and
a memory, the memory storing the personal data associated with the code;
a server transmitter in communication with the server receiver, the server transmitter transmitting the requested personal data in response to the server receiver receiving the personal data request message.

9. The system of claim 8, wherein the server transmitter transmits the code to imprint to the symbology device.

10. A method for imprinting symbology corresponding to personal data, the method comprising:
determining personal data corresponding to a person;
determining a code to imprint based at least in part on the personal data, at least a portion of the personal data being represented in the code; and
imprinting the code onto the person.

11. The method of claim 10, wherein the code is imprinted onto the person using at least one of a first ink visible under a visible light spectrum and second ink visible under an ultraviolet light spectrum.

12. The method of claim 10, wherein the personal data is associated with a file, the file being at least one of a text file, a sound file, a multimedia file, and a graphical file, the text file including a uniform resource locator (URL) to a website associated with the user.

13. The method of claim 10, wherein the personal data includes at least one of a government identification and a social media user identification associated with the person.

14. The method of claim 10, wherein the code is imprinted onto the person by at least one of a laser based mechanism and needle based injection mechanism.

15. The method of claim 10, further comprising:
receiving a personal data request message; and
transmitting the requested personal data in response to receiving the personal data request message.

16. The method of claim 15, wherein the personal data request message includes at identification of a requestor having a corresponding personal data access level, and wherein transmitting further includes transmitting personal data corresponding to the personal data access level.

17. A tangible computer readable medium storing computer readable instructions that when executed by a processor, cause the processor to perform operations including:
determining personal data corresponding to a person;
determining a code to imprint based at least in part on the personal data, at least a portion of the personal data being represented in the code; and
controlling imprintation of the code onto the person.

18. The computer readable medium of claim 17, wherein the personal data includes a uniform resource locator (URL) to a website associated with the user.

19. The computer readable medium of claim 17, wherein the personal data includes at least one of a government identification and a social media user identification associated with the person.

20. The computer readable medium of claim 17, wherein the personal data is categorized in different security levels.

21. The computer readable medium of claim 17, wherein the code is one of a one dimensional code and a two dimensional code.

22. A method for imprinting symbology corresponding to a creature, the method comprising:
determining creature data corresponding to a creature;
determining a code to imprint based at least in part on the creature data, at least a portion of the creature data being represented in the code; and
imprinting the code onto the creature.
